(19) United States
(12) Patent Application Publication
(10) Pub. No.: US 2008/0065703 A1
(43) Pub. Date: Mar. 13, 2008

(54) Configurable views of archived data storage

(75) Inventors: You Wang, Longmont, CO (US); Steven Fredrick Hartung, Boulder, CO (US); Dworkin Loki Muller, Longmont, CO (US)

Correspondence Address: Trellis Intellectual Property Law Group, PC, 1900 EMBARCADERO ROAD, SUITE 109, PALO ALTO, CA, 94303, US

(73) Assignee: COPAN Systems, Inc., Longmont, CO (US)

(21) Appl. No.: 11/710,238

(22) Filed: Feb. 22, 2007

Related U.S. Application Data
(60) Provisional application No. 60/775,946, filed on Feb. 22, 2006.

(51) Int. Cl. G06F 17/30; G06F 12/00

(52) U.S. Cl. 707/203; 707/201; 707/E17.005

(57) ABSTRACT

In one embodiment, a method for creating a view for a plurality of data units is provided. A portion of the plurality of data units are stored in one or more storage drives that are in a lower power mode of operation in the storage system. The method includes determining a subset of data units stored in a storage system based on one or more filter criteria. Metadata is determined that represents the subset of data units in the storage system. A view is then created from the metadata. For example, a dynamic or static view may be created. The view is then stored such that it is always accessible on an always on storage drive. The metadata may be used to provide information about the data units in the storage drives that are in a lower power mode of operation without having to power on the storage drives.

### CROSS REFERENCES TO RELATED APPLICATIONS

This application claims priority from U.S. Provisional Patent Application Ser. No. 60/775,946 entitled “CONFIGURABLE VIEWS OF ARCHIVED DATA STORAGE”, filed on Feb. 22, 2006, which is hereby incorporated by reference as if set forth in full in this application for all purposes.

### BACKGROUND

Embodiments of the present invention generally relate to storage systems and more specifically to creating configurable views for archival storage systems.

It is often critical to make back-up or archival copies of data. Archiving can be useful to free up a primary storage system for additional data, to allow data to be restored after it becomes lost, destroyed, or corrupted, to improve system efficiency for data that is accessed infrequently, and for other reasons.

A storage system may be storing a large amount of files (e.g., billions, etc.). Performing tasks with a file system that includes all of these files may be hard to manage and be slow. For example, exposing the billions of files to a user may be useless and confusing to the user. Thus, the archived data in a storage system may not be accessible as easily as desired.

### BRIEF DESCRIPTION OF THE DRAWINGS

FIG. 1 shows a system for creating different views according to one embodiment.

FIG. 2 illustrates a block diagram of an archival system, in accordance with various embodiments.

FIG. 3 depicts a system for creating dynamic and static views according to one embodiment.

FIG. 4 depicts a simplified flow chart of a method for creating a static view according to one embodiment.

FIG. 5 depicts a simplified flow chart of a method for creating a dynamic view according to one embodiment.

### SUMMARY

In one embodiment, a method for creating a view for a plurality of data units is provided. A portion of the plurality of data units is stored in one or more storage drives that are in a lower power mode of operation in a storage system. The method includes determining a subset of data units stored in a storage system based on one or more filter criteria. Metadata is determined that represents the subset of data units in the storage system. A view is then created from the metadata. For example, a dynamic or static view may be created. The static view may be a view of data units that does not change over time. The dynamic view may be updated as data units change, such as when a version of a file changes. The view may represent information about the data units, such as the owner information, versioning information, description of the content, etc. Also, the view may be stored as a file tree that represents how a structure of the data units is stored in the storage system. The view is then stored such that it is always accessible on a powered on storage drive. The metadata is for one or more data units in the subset of the data units that are stored in one or more storage drives that are in the lower power mode of operation. However, the metadata may be used to provide information about the data units in the storage drives that are in a lower power mode of operation without having to power on the storage drives.

A further understanding of the nature and the advantages of particular embodiments disclosed herein may be realized by reference of the remaining portions of the specification and the attached drawings.

### DETAILED DESCRIPTION OF EMBODIMENTS

Particular embodiments generate views of subsets of files in a storage system. A system may have a large amount of files archived. Views of the files in the system may include metadata for subsets of the data stored in the archive storage system. The metadata may be used to perform actions, such as creating displays of where data is stored in archive storage system, moving data around in the storage system, etc. The metadata includes attributes for the archived data and the views may always be stored on a powered on drive. The archived data, however, may be stored on drives that are in a powered down state. But, because the metadata is accessible, attributes for the data may be used to provide information for the archived data.

Because the archive storage system may include a large number of files, it may be hard to manage all the files. Thus, views are created that include metadata for a subset of the archived data. For example, an archive view represents a selected subset of the files in a massive array of idle disks (MAID) File Archiver as a single file tree. Views are created by selecting the files via file filter specifications. The views are created using the metadata for the archived files.

Different views may be created. For example, dynamic and/or static views may be created. Also, other views may be appreciated, such as hybrids of the dynamic or static views.

A dynamic view tracks changes in the archive and substitutes the updated files when newer versions of the files become available. In one embodiment, dynamic views can be accomplished either by mounting the selected file sets as an union file system or a filter stack file system layer may be placed on top of a file system of metadata, such as a farfs (File Archiver read-only file system) metadata file system, that presents the correct files to the requesters on a real-time basis.

Static views are snapshots of the selected files at the time when the views are created. Static views are useful when users want all versions of a specific file set to be presented in a single file tree. Static views are accomplished by duplicating the metadata files or mounting the selected file sets as union file systems.

Views are important to a MAID archive system with billions of files where it is almost impossible to present all the files to users in a single file tree. Views make it possible to present all the archived files via multiple smaller file trees in a manageable manner even when the actual data files are on drives that are offline. Views also help in presenting to the requester only the files that the requester has been granted permission to access. Fundamentally, views allows the archival system to decouple the stored representation from the user's logical access, enabling both ease of navigation, search and retrieval, versioning access, and imposing a security framework.

Files are stored in an archive system in a way that facilitates the tracking of stored files by the system, which can be very different from how the user conceives of their file organization. The view provides a mechanism to present the archive to the user and user's systems that is under user control. Tree and name mangling are avoided in the user's domain, while still making it possible to archive multiple versions of the same file and to collect files from many different sources and present them in a unified tree from the archive.

In an archive, actual files may not be always immediately accessible. Instead files may be represented by file metadata, and exposed through an exported networked filesystem as if they were the actual data files. The actual data files may be only retrieved for data content I/O. The view allows collecting a subset of the archive's files as a new filesystem tree from select metadata files only. The selection is based on a filter criteria specified by the user. Examples of filter criteria are the data and time, filename wild card, the owning user and group, etc., which may be similar to the criteria that can be used to select which files to archive. In one embodiment, the metadata files that match the filter can then be copied to a filesystem within a file in a tree that matches the user's expectation. That file tree can then be exported via the filesystem for access by the users.

In one embodiment of the dynamic view, the “view filesystem” is updated whenever a new file is archived that supersedes a file in the view. In such a case the metadata file in the view is updated to reflect the new file. The dynamic view may implement the concept of a union file system by mounting the selected file sets as a union and the union filesystem reflects the updates and change in the archive in real time when newer versions are archived. A system may have hundreds or thousands of views defined, so the indirection is much more efficient during dynamic updates.

In another embodiment, the dynamic view may be implemented as a new stacked filesystem that has global access to the metadata for all archived files. Each tree and file information request can then be generated on-the-fly by applying the filter rule defined by the user. This has the advantage of only needing to calculate the filter application when a request comes in, thus reducing overhead at archive time; it also uses less disk space because multiple copies of the metadata files are not being stored (one in each view).

A hybrid system of the two dynamic view embodiments described above are also possible, where some portions of the tree are defined by metadata copies exported by the file system (e.g. the directory structure and single instance files) while others are calculated on-the-fly (e.g., symbolic links to the latest version or to the nth version).

In one embodiment, the Static view is the hybrid of union file system mounts and metadata duplicating. Using the union file system may be more efficient. Metadata duplication may be used when file system union is not able to achieve a view defined by the users. In one example, a user may want a file tree to include all versions of a specific file set in the archiver. In one embodiment, the solution is tailored to the metadata tracking system of the COPAN MAID data archiving system implemented in the MILLENNIA ARCHIVE™ software. However, it should be apparent that, in general, any other software, hardware, or combination of software and hardware can be used to achieve the various functions described herein, including those performed by the Millenium Archive Software. Embodiments of the invention are not limited to this application. Embodiments can be used in any system that needs to reorganize or filter the presentation of large archived file sets. Embodiments may leverage a stacked metadata based filesystem “farfs” but may leverage other file systems.

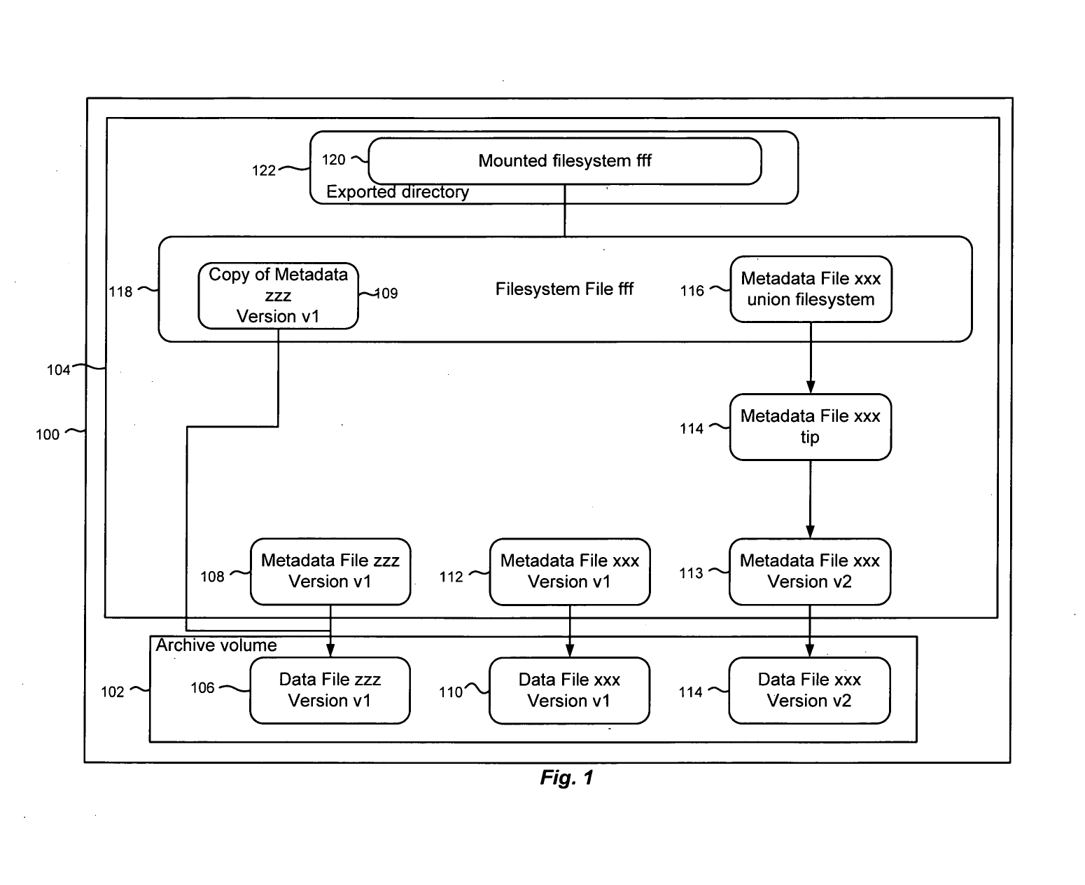

FIG. 1 shows a system 100 for creating different views according to one embodiment. An archive volume 202 shows files that have been archived. As shown, data file zzz (v1) 106, data file xxx (v1) 110, and data file xxx tip 114 are archived. Data file xxx has two versions, v1 and v2 that have been archived.

A metadata volume 104 includes metadata for data files in archive volume 202. The metadata is used to build a view. Thus, a view can be built without having the actual files accessible.

Metadata zzz (v1) 108 is metadata for data file zzz (v1) 106. Also, metadata xxx (v1) 112 is metadata for data file xxx (v1) 110, and metadata xxx (v1) 113 is metadata for data file xxx (v2) 114.

Filesystem File fff 118 may be a summary of metadata found for data files. For example, metadata File xxx Union filesystem 116 is a union of all metadata found below (e.g., metadata file xxx tip 114 and metadata File xxx (v1) 112. The union may be updated every time files are archived where metadata is affected. For example, metadata File xxx Union filesystem 116 may be updated to represent that a second version of Data File xxx has been archived. A copy of Metadata zzz (v1) 109 is also included in Filesystem File fff 118. This represents the updated metadata for Data File zzz (v1) 106. Since there is only one version, the metadata for the only version is copied into fff 118.

Filesystem fff 118 may be mounted onto a mounted Filesystem fff 120 through an exported directory 122. As used in this application, a “mounted” filesystem is one whose data (e.g., files, metadata, etc.) resides in media that can be accessed relatively quickly, such as in a primary drive system with powered on, spun-up, active disk drives. An unmounted filesystem is one whose data may not be as quickly accessible, such as in a secondary (slower) drive system or one where drives are spun-down, placed in standby or low power modes, powered off, etc. Features of embodiments of the invention can operate in a power-managed MAID storage system. In such a system a large number of drives may be powered off at any one time. However, features of the invention can also be used in any type of generalized storage system, filesystem or archive approach.

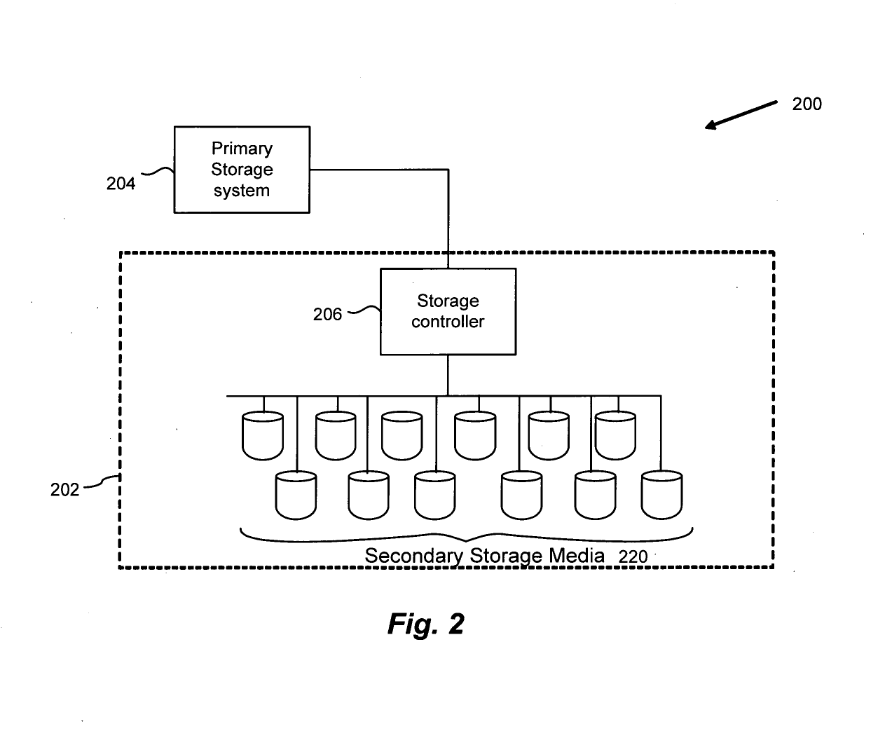

FIG. 2 illustrates a block diagram of an archival system 200, in accordance with various embodiments. Particular embodiments include features for enabling data archiving in computer systems. Archival system 200 includes a secondary storage system 202, a primary storage system 204, and a storage controller 206. Archival system 200 enables a user of the storage system 200 to store data units from the primary storage system 204 in the secondary storage system 202. The data units stored in the secondary storage system 202 may be one or more data units containing information or data. Further, the secondary storage system 202 may include one or more data drives which may be powered-on or on a lowered powered mode of operation at a given moment of time. The data units present in the primary storage system 204 can be archived in the secondary storage system 202. The secondary storage system 202 further includes a plurality of secondary storage media 110. The one or more disk drives in the plurality of the secondary storage media 110 can be in a powered-on mode or in a lower power mode of operation. The one or more disk drives of the plurality of the plurality of secondary storage media 110 containing the data units may be powered-on from a lower power mode of operation when the user of the archival system 200 retrieves the data units from the plurality of secondary storage media 110. In an embodiment, the second secondary storage medium may be in a lowered power mode of operation as compared to the first secondary storage medium. For example, the second secondary storage medium may be spinning at a lower speed or may be idle as compared to the first secondary storage medium. Further, the lower power mode of operation may include a powered off state or standby state. Access to the data units from a secondary storage medium in the lower power mode of operation may be slower than if the second storage medium is powered on.

The storage controller 206 is capable of interpreting the commands received from the user of the storage system 200. The storage controller 206 is capable of interpreting the one or more commands sent by the user of the archival system 200. The storage controller 206 then carries out various operations on the secondary storage system 202 based on the commands that are provided by the user of the archival system 200. Storage controller 206 may send commands for creating static and dynamic views. Also, the user of the archival system 200 can direct the storage controller 206 to perform operations such as archival of data units in the secondary storage system 202, retrieval of data units from the secondary storage system 202 to the primary storage system 204.

The storage controller 206 of the archival system 200 may be on a computing device. Storage controller 206 may include a user interface, which helps a user to manage various tasks that need to be carried out at the archival system 200. These tasks may include tasks associated with the views, such as defining filter criteria for views, accessing views, creating views, etc. Also, other task include, but are not limited to, archiving various data units present in the primary storage system 204 into the secondary storage system 202 and retrieving data units that are stored on the secondary storage system 202. The user interface may display information that is determined based on the views that are created.

In an embodiment, the views may be created a power managed redundant array of independent/inexpensive disks (RAID) system or a power managed massive array of independent/inexpensive disks (MAID) system. In a power managed storage system only a limited number of storage devices are powered on at a time according to a maximum permissible power consumption or “power budget.” Power-managed RAID systems are described in, for example, U.S. Pat. No. 7,035,972, entitled ‘Method and Apparatus for Power Efficient High-Capacity Storage System’, which is incorporated herein by reference, as if set forth in this document in full for all purposes.

The user the storage system 200 may view information about the one or more data units stored on the secondary storage system 202 when the plurality of secondary storage media 110 is in a lower power mode of operation. The storage controller 206 of the archival system 200 maintains metadata of the data units in views where the data is stored in the secondary storage system 202. The metadata may include one or more attributes pertaining to the data units that are stored in the plurality of secondary storage media 110. Because the data units are stored on secondary storage media 110 that may be in a powered down state, the views are stored in storage media that is in a powered on state. Thus, when information about the data is requested, such as by a user for creating a display of the file system, the metadata in the views may be used to satisfy the request. In performing the request, powered down drives that may be storing the data do not have to be powered on because the metadata is used to satisfy the request.

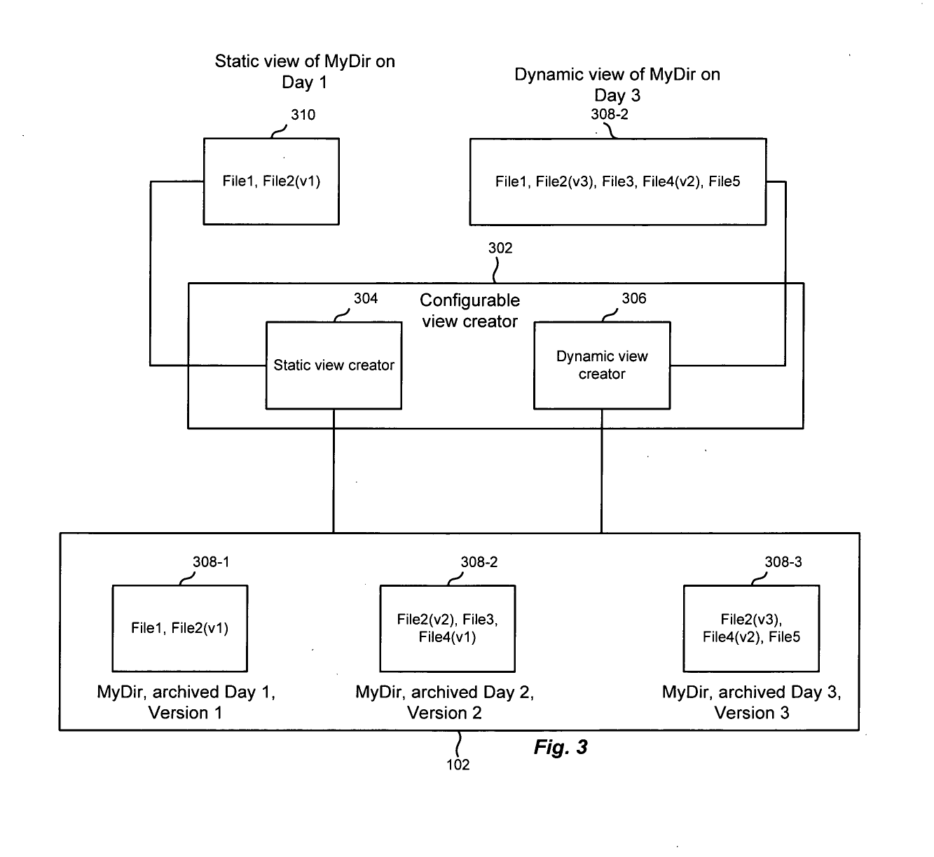

FIG. 3 depicts a system for creating dynamic and static views according to one embodiment. As shown, a configurable view creator 302 includes a static view creator 304 and a dynamic view creator 306. View creator 302 may be included in storage controller 206 or any other device. Secondary storage system 202 includes a plurality of directory versions 308 that have been archived.

Directory version 308-1 represents files that were archived on day 1 and includes files File1 and File2 (v1).

Directory version 308-2 represents files that were archived on day 2 and includes File2 (v2), File 3, and File 4 (v1). In this case, a new version of File 2 is archived in addition to new files, File 3 and File 4 (v1).

Directory version 308-3 represents files that were archived on day 3 and includes File2 (v3), File 4 (v4), and File 5. In this case, new versions of File 2 and File 4 are archived in addition to a new file, File 5.

The versions 308 may form a directory that includes all of the files archived in each version. Metadata for these files may also be created. Thus, even though files may not be available, the metadata may be used to create a view.

Static view creator 304 creates a static view 310. The static view is a view that may not change. Different filters may be used to create the static view. For example, a view may be created for a day, version, etc. Static view creator 304 may create static views 310 that do not change over time.

In one example, static view 310 is created to show a directory version for day 1. As shown, static view 310 includes the files: File 1 and File 2 (v1). This is the view of files on day 1. Static view 310 may be created using metadata that represents the files. Metadata for the requested files may be mounted and created in a tree. The tree is then used to form static view 310.

Dynamic view creator 306 may create a dynamic view 312. The dynamic view may change over time. For example, filter criteria may be used to create a dynamic view. The information returned for the filters may change over time. For example, as files are archived, this may affect the files that are returned because they may meet the criteria for the filters. Thus, dynamic view 312 may be updated as changed occur.

In one embodiment, dynamic view 312 updates files for a view when newer versions are archived. In one example, the criteria for dynamic view 312 may be used to create a view with updated files. As shown, dynamic view 312 includes the files: File1, File 2 (v3), File 4 (v2), and File 5. This shows the most recent versions of files in directory 202. Even though there are multiple versions of files, such as versions v1 and v2 for File 2 and version v1 for File 4 that were created on days 1 and 2, dynamic view 312 is updated to show the latest versions on day 3.

As the archiving takes place, new metadata may be created. As this new metadata is created, dynamic view creator 306 may update dynamic view 312 using the metadata.

The views that are created may be mounted in a file that is stored on a powered on drive. For example, the file may be stored in primary storage system 204. The views may be provided in a manageable manner in file trees. The views may be accessed even if the actual files are in drives that are in a powered down state. Thus, if information for the data is needed, the metadata may be used to display attributes for the data even though the data is stored on drives that are powered down. Accordingly, a powered down drive does not have to be powered on to access information about the data. Rather, the metadata provides information about the data.

The views represent specific organizations of subsets of data. Thus, this enables actions to be performed with manageable portions of the data stored in secondary storage media. For example, attributes for the data may be searched, retrieved, accessed, etc. Ease of navigation among the attributes for the data in the views is provided. For example, a user interface may be provided that shows an organization of a subset of the data in secondary storage media 202 without having to access the drives in which the data is stored. Thus, the drives can be in a powered down state. If the data needs to be retrieved from secondary storage media 202, then the drives may be powered on and the data is retrieved.

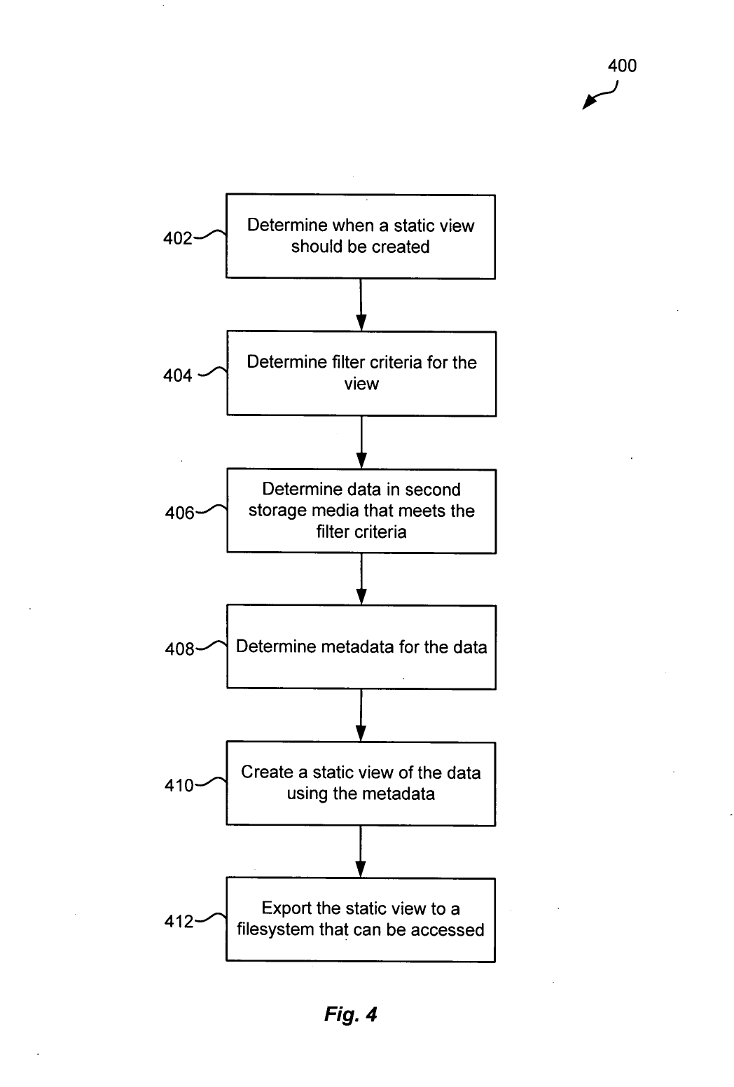

FIG. 4 depicts a simplified flow chart 400 of a method for creating a static view according to one embodiment. Step 402 determines when a static view should be created. A static view is only created once. The static view stays the same even if data in the files that the view was created from changes.

Step 404 determines filter criteria for the view. The filter criteria may be any criteria that can select subsets of data. The filter criteria may be selected by a user. Examples of filter criteria include data, time, filename wildcard, owning user and group, etc.

Step 406 determines data in second storage media 202 that meets the filter criteria. Step 408 then determines metadata for the data. The metadata includes attributes for the data. For example, the metadata may include the name of the file, description of the contents, date archived, owner, versioning, etc.

Step 410 then creates a static view of the data using the metadata. The static view may be a file tree of metadata. Step 412 then exports the static view to a filesystem that can be accessed. For example, the static view is always stored on a drive that is in a powered on state.

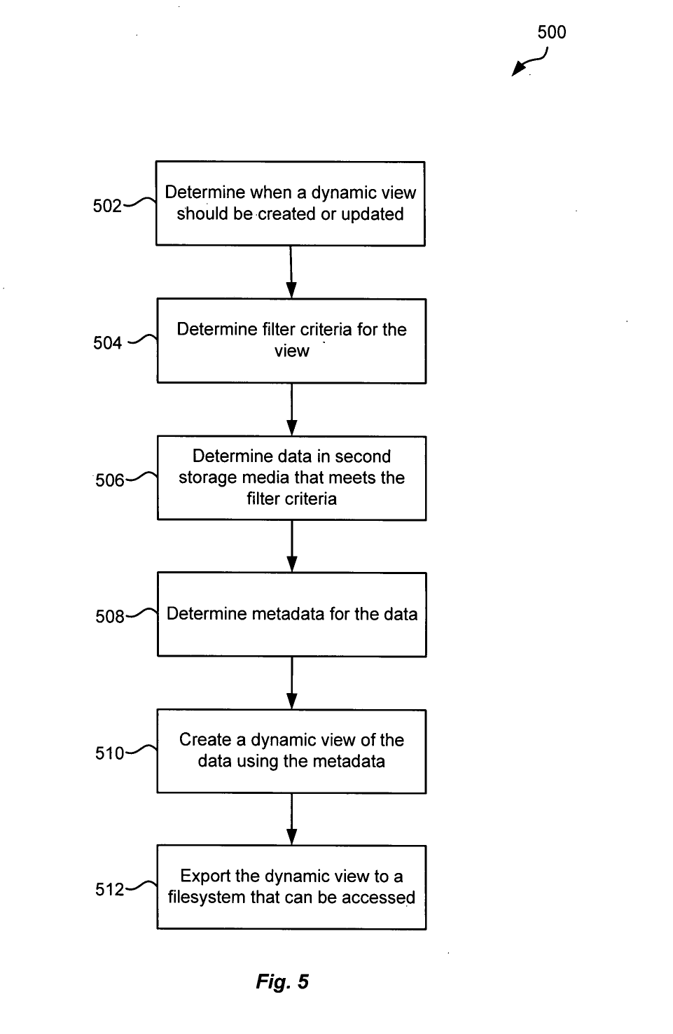

FIG. 5 depicts a simplified flow chart 500 of a method for creating a dynamic view according to one embodiment. Step 502 determines when a dynamic view should be created or updated. A dynamic view is updated when data for the view changes. For example, whenever a file that is included in the view is superseded by another file (e.g., another version of the file), then a new dynamic view may be created.

Step 504 determines filter criteria for the view. The filter criteria may be any criteria that can select subsets of data and may be selected by a user. In one example, the filter criteria may detect when changes to data for the view occur.

Step 506 determines data in second storage media 202 that meets the filter criteria. For example, the change in the data is detected.

Step 508 then determines metadata for the data. The metadata includes attributes for the data. For example, metadata for the changed data is determined.

Step 510 then creates a dynamic view of the data using the metadata. The dynamic view of an previously created dynamic view may be updated with new metadata.

Step 512 then exports the dynamic view to a filesystem that can be accessed. For example, the dynamic view is always stored on a drive that is in a powered on state.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method for creating a view for a plurality of data units, wherein a portion of the plurality of data units are stored in one or more storage drives that are in a lower power mode of operation in the storage system, the method comprising:
determining a subset of data units stored in a storage system based on one or more filter criteria;
determining metadata representing the subset of data units in the storage system;
creating a view using the metadata; and
storing the view such that it is always accessible on a powered on storage drive, wherein the metadata is for one or more data units in the subset of the data units are stored in one or more storage drives that are in the lower power mode of operation.

2. The method of claim 1, wherein the view comprises a static view, wherein the static view does not change after being created even if the subset of data units change.

3. The method of claim 1, wherein the view comprises a dynamic view, wherein the dynamic view is updated when changes to the subset of data occur.

4. The method of claim 3, further comprising tracking when changes to the subset of the data units occur based on the one or more filter criteria.

5. The method of claim 3, wherein the dynamic view is created using a union file system or a filter stack file system layer that may be placed on top of a metadata file system.

6. The method of claim 1, wherein the filter conditions are defined by a user.

7. The method of claim 1, wherein the view is stored as a file tree representing a structure of the subset of data units stored in the storage system.

8. The method of claim 1, further comprising:
receiving a request for information associated with a data unit in the subset of data units;
determining metadata for the data unit in the view; and
servicing the request for information using the determined metadata.

9. The method of claim 8, wherein data unit is stored on a storage drive that is in a powered down state, wherein the request is serviced without powering on the storage drive.

10. An apparatus configured to create a view for a plurality of data units, wherein a portion of the plurality of data units are stored in one or more storage drives that are in a lower power mode of operation in the storage system, that apparatus comprising:
one or more processors; and
logic encoded in one or more tangible media for execution by the one or more processors and when executed operable to:
determine a subset of data units stored in a storage system based on one or more filter criteria;
determine metadata representing the subset of data units in the storage system;
create a view using the metadata; and
store the view such that it is always accessible on a powered on storage drive, wherein the metadata is for one or more data units in the subset of the data units are stored in one or more storage drives that are in the lower power mode of operation.

11. The apparatus of claim 10, wherein the view comprises a static view, wherein the static view does not change after being created even if the subset of data units change

12. The apparatus of claim 10, wherein the view comprises a dynamic view, wherein the dynamic view is updated when changes to the subset of data occur.

13. The apparatus of claim 12, wherein the logic when executed is further operable to track when changes to the subset of the data units occur based on the one or more filter criteria.

14. The apparatus of claim 12, wherein the dynamic view is created using a union file system or a filter stack file system layer that may be placed on top of a metadata file system.

15. The apparatus of claim 10, wherein the filter conditions are defined by a user.

16. The apparatus of claim 10, wherein the view is stored as a file tree representing a structure of the subset of data units stored in the storage system.

17. The apparatus of claim 10, wherein the logic when executed is further operable to:
receive a request for information associated with a data unit in the subset of data units;
determine metadata for the data unit in the view; and
service the request for information using the determined metadata.

18. The apparatus of claim 17, wherein data unit is stored on a storage drive that is in a powered down state, wherein the request is serviced without powering on the storage drive.

19. An apparatus configured to create a view for a plurality of data units, wherein a portion of the plurality of data units are stored in one or more storage drives that are in a lower power mode of operation in the storage system, the apparatus comprising:
means for determining a subset of data units stored in a storage system based on one or more filter criteria;
means for determining metadata representing the subset of data units in the storage system;
means for creating a view using the metadata; and
means for storing the view such that it is always accessible on a powered on storage drive, wherein the metadata is for one or more data units in the subset of the data units are stored in one or more storage drives that are in the lower power mode of operation.
